(19) United States
(12) Patent Application Publication
(10) Pub. No.: US 2020/0067363 A1
(43) Pub. Date: Feb. 27, 2020

(54) WOUND STATOR FOR ROTATING ELECTRICAL MACHINE

(71) Applicant: Valeo Equipements Electriques Moteur, Creteil (FR)

(72) Inventors: Vincent Ramet, Étaples-Sur-Mer (FR); Sébastien Leclercq, Étaples-Sur-Mer (FR); Alain Defebvin, Étaples-Sur-Mer (FR); Eric Delcroix, Étaples-Sur-Mer (FR)

(73) Assignee: Valeo Equipements Electriques Moteur, Creteil (FR)

(21) Appl. No.: 16/476,392

(22) PCT Filed: Jan. 8, 2018
(86) PCT No.: PCT/FR2018/050039

§ 371 Date: Jul. 8, 2019

(30) Foreign Application Priority Data
Jan. 6, 2017 (FR) 1750137

(51) Int. Cl. H02K 3/28; H02K 15/04

(52) U.S. Cl. CPC H02K 3/28; H02K 15/0485

(57) ABSTRACT

The present invention provides a stator for a rotating electrical machine, in particular for a motor vehicle, the stator (15) comprising: —a body (27) having notches (37) which open axially into front (38) and rear (39) axial end walls of the body (27) and which are radially open in an inner wall (40) of the body (27), —at least two windings (43), each forming a phase of the stator (15), each winding comprising modulating wire turns which comprise a series of axial strands (44) received in a series of associated notches (37) and connecting strands (45, 46) which connect the successive axial strands (44) and extend alternately beyond the front axial end wall (38) and beyond the rear axial end wall (39). One winding has a shorter wire length than the other winding.

The invention relates in particular to a wound stator equipped with windings forming phases for a rotary electrical machine of a motor vehicle.

The invention has a particularly advantageous application in the field of rotary electrical machines such as alternators, alternator starters, or also reversible machines. It will be remembered that a reversible machine is a rotary electrical machine which can work reversibly, firstly as an electric generator when functioning as an alternator, and secondly as an electric motor, for example in order to start the thermal engine of the motor vehicle.

A rotary electrical machine comprises a rotor which is mobile in rotation around an axis, and a fixed stator surrounding the rotor. In alternator mode, when the rotor is rotating, it induces a magnetic field on the stator, which transforms it into electric current in order to supply power to the vehicle electronics and recharge the battery. In motor mode, the stator is supplied electrically, and induces a magnetic field which rotates the rotor.

The invention relates more particularly to a stator of a rotary electrical machine comprising an annular cylindrical body provided with axial notches which open out, in which electrical conductors are arranged such as to form a winding. In this case, the winding is formed by a plurality of phases, and is composed of conductors delimiting a series of turns or loops which are connected electrically in series, and form a circumferential winding. A winding comprises axial branches which pass through the notches, and connection branches disposed on the exterior of the cylindrical body which form the connection between the different axial branches. The connection branches then form a front chignon and a rear chignon extending projecting axially on both sides of the cylindrical body.

Stators comprising this type of winding are already known for example from document FR 2819118.

During the production of a stator of this type, the phases are inserted one after another in the notches. The space for insertion of the phases is gradually reduced as the phases are put into place in the body. Thus, the difficulty of insertion of the phases increases with the insertion of the following phase.

This results in different axial positioning between the phases, with the first phases inserted being positioned higher axially than the final phases inserted. The axial heights of the chignons extending on both sides of the cylindrical body are thus not homogenous within a single chignon, since the different phases form waves which are more or less low or high according to the position of the phases.

This phenomenon of axial offsetting of the phases gives rise to an increase in the global height of the front and rear chignons of the stator. Having large heights of chignons has a negative impact on the rotary electrical machine. In fact, this gives rise firstly to an increase in the size of the said machine, and secondly to a decrease in the performance of the said machine, since it is known that the electric current which circulates in the chignons creates losses. In addition, this also gives rise to an increase in the production cost of the machine, by increasing the quantity of conductors necessary to create the winding.

The objective of the invention is to make it possible to prevent the disadvantages of the prior art.

For this purpose, the subject of the invention is thus a stator for a rotary electrical machine, in particular for a motor vehicle. According to the present invention, the stator comprises:
a body comprising notches which open axially into front and rear axial end walls of the body, and are open radially in an inner wall of the body;
at least two windings each forming a phase of the stator, each winding comprising undulating turns of wire which comprise a series of axial strands received in an associated series of notches, and connection strands which connect the successive axial strands, by extending alternately projecting relative to the front axial end wall and projecting relative to the rear axial end wall.

According to the invention, one winding has a wire length which is shorter than that of the other winding.

Unexpectedly, it has been found that the fact of reducing the length of one of the windings, and thus creating imbalance of the length of one phase relative to another phase, does not affect the electromagnetic performance of the rotary electrical machine. This reduction of length makes it possible to reduce the axial height of the chignon, and in particular that of the rear chignon of the machine. The axial size of the machine is thus reduced, as is its weight and its production cost.

According to one embodiment, the stator comprises two phase systems, each phase system comprising at least one winding. In this embodiment, at least one winding of the second phase system has a wire length which is shorter than that of a winding of the first phase system.

According to one embodiment, each phase system comprises a plurality of windings, and all the windings of the second phase system each have a wire length which is shorter than that of the windings of the first phase system.

According to one embodiment, within a single phase system, the windings have the same wire length. This makes it possible not to create imbalance of the resistances within a single phase system, and thus to avoid a decrease in the performance of the electrical machine.

According to one embodiment, the winding with a shorter wire length is disposed radially closer to the inner wall of the stator body than the winding with the longer wire length.

For example, the second phase system is disposed radially closer to the inner wall of the stator body than the first phase system.

According to one embodiment, the length of the winding which has a shorter wire length is at the most equal to 98% of the length of the winding which has a longer wire length. This makes it possible to reduce the length of the wire sufficiently in order to have a real decrease in the height of the chignon.

According to one embodiment, the length of the winding which has a shorter wire length is at least equal to 95% of the length of the winding which has a longer wire length. This makes it possible not to decrease the wire length too much. In fact a minimum wire length is required in order to be able to wind the winding correctly in the body of the stator.

According to one embodiment, the difference in resistance between the winding which has a shorter wire length and the winding which has a longer wire length is approximately 3%, with the winding which has a shorter wire length having the lower resistance.

According to one embodiment, a winding comprises a first half-phase forming an outer layer of turns and a second, inner half-phase forming an inner layer of turns superimposed radially in the notch on the outer layer. In this embodiment, the axial strands of each half-phase are disposed in the notches such that the axial strands of the second half-phase are radially closer to the inner wall than the axial strands of the first half-phase. Again in this embodiment, the connection strands of the first half-phase form outer chignons and the connection strands of the second half-phase form inner chignons, with the inner and outer chignons extending projecting axially relative to the front and rear axial end walls of the body.

According to one embodiment, the turns of each half-phase of a single winding undulate in opposition.

According to one embodiment, the wire length of each turn of the first half-phase and that of each turn of the second half-phase are identical for a single winding.

According to another embodiment, the wire length of each turn of the second half-phase is longer than the wire length of each turn of the first half-phase, such that a projecting axial height of the inner chignons is greater than a projecting axial height of the outer chignons.

For example, the wire length of each turn of the second half-phase is greater by 2% to 10% than the wire length of each turn of the first half-phase.

The subject of the present invention is also a rotary electrical machine. The rotary electrical machine can advantageously form an alternator, an alternator-starter or a reversible machine.

The present invention will be able to be better understood by reading the following detailed description of non-limiting embodiments of the invention, and by examining the appended drawings in which:

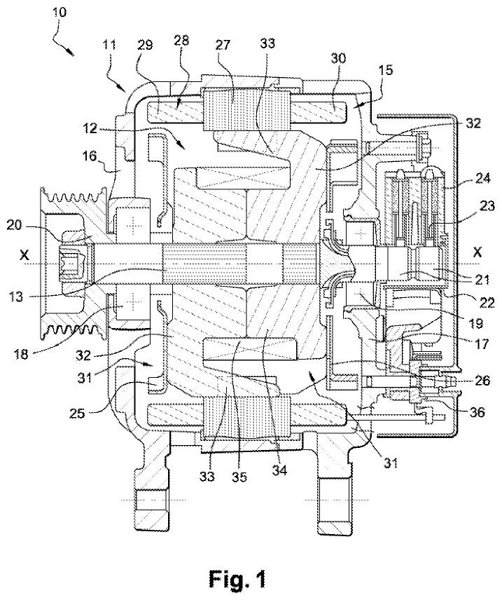

FIG. 1 represents schematically and partially a view in cross-section of a rotary electrical machine according to an embodiment of the invention;

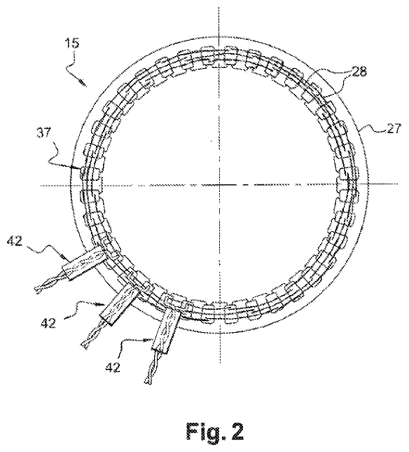

FIG. 2 represents schematically and partially a view from above of a wound stator in FIG. 1;

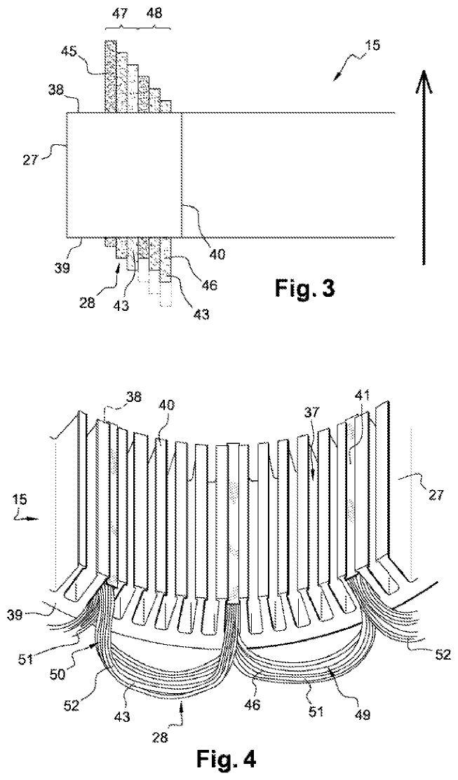

FIG. 3 represents schematically and partially a side view of a part of a wound stator in FIG. 1;

FIG. 4 represents schematically and partially a view in perspective of a part of a stator wound partially in FIG. 1;

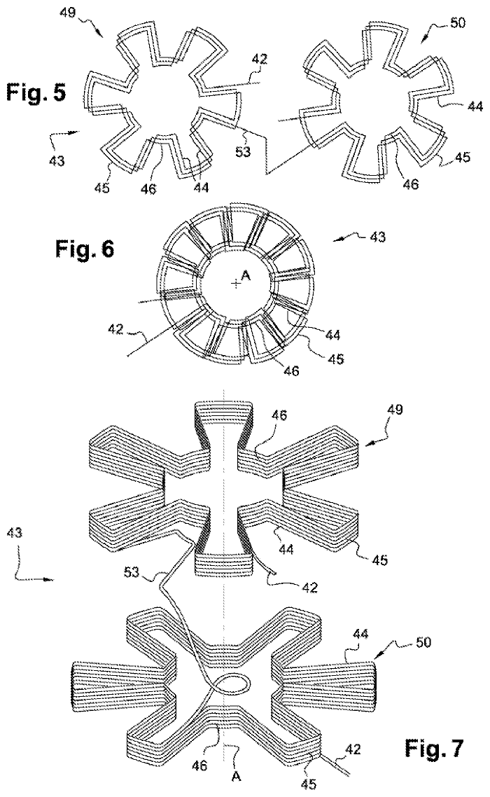

FIG. 5 represents schematically and partially an exploded view from above which represents two half-phases of the winding in FIG. 4 before assembly (with a reduced number of turns in order to simplify the figure);

FIG. 6 represents schematically and partially a view from above which represents the winding in FIG. 5 in which the two half-phases are superimposed axially; and

FIG. 7 represents schematically and partially a view in perspective of the two half-phases of the winding in FIG. 4.

Elements which are identical, similar or analogous retain the same references from one figure to another.

The embodiments which are described hereinafter are in no way limiting; in particular, it will be possible to conceive of variants of the invention which comprise only a selection of characteristics described hereinafter, isolated from the other characteristics described, if this selection of characteristics is sufficient to provide a technical advantage, or to differentiate the invention from the prior art. In particular, all the variants and all the embodiments described can be combined with one another, if nothing opposes this combination from a technical point of view. In such a case, this will be mentioned in the present description.

FIG. 1 represents an example of a compact polyphase rotary electrical machine 10, in particular for a motor vehicle. This rotary electrical machine 10 transforms mechanical energy into electrical energy in alternator mode, and can operate in motor mode in order to transform electrical energy into mechanical energy. This rotary electrical machine 10 is for example an alternator, an alternator-starter or a reversible machine.

The rotary electrical machine 10 comprises a housing 11. In the interior of this housing 11 it also comprises a shaft 13, a rotor 12 which is integral in rotation with the shaft 13, and a stator 15 which surrounds the rotor 12. The movement of rotation of the rotor 12 takes place around an axis X.

Hereinafter in the description, the terms axial, radial, external and internal refer to the axis X which passes through the shaft 13 in its centre. The axial direction corresponds to the axis X, whereas the radial orientations correspond to planes which are concurrent with, and in particular perpendicular to, the axis X. For the radial directions, the terms external or internal are understood relative to the same axis X, with the term internal corresponding to an element which is oriented towards the axis, or closer to the axis than a second element, and the term external designating distancing from the axis.

In this example, the housing 11 comprises a front bearing 16 and a rear bearing 17 which are assembled together. These bearings 16, 17 have a hollow form, and each support centrally a respective ball bearing 18, 19 for fitting of the shaft 13 with rotation.

A pulley 20 is secured on a front end of the shaft 13, at the front bearing 16, for example by means of a nut supported on the base of the cavity of this pulley. This pulley 20 makes it possible to transmit the movement of rotation to the shaft 13.

In this case, the rear end of the shaft 13 supports collector rings 21 belonging to a collector 22. Brushes 23 belonging to a brush-holder 24 are disposed such as to rub on the collector rings 21. The brush-holder 24 is connected to a voltage regulator (not represented).

The front bearing 16 and the rear bearing 17 can also comprise substantially lateral openings for the passage of the air, for the purpose of permitting cooling of the rotary electrical machine by circulation of air generated by the rotation of a front fan 25 on the front dorsal face of the rotor 12, i.e. at the front bearing 16, and by the rotation of a rear fan 26 on the rear dorsal face of the rotor, i.e. at the rear bearing 17.

In this example, the rotor 12 is a rotor with claws. It comprises two magnet wheels 31. Each magnet wheel 31 is formed by a flange 32 and a plurality of claws 33 forming magnetic poles. The flange 32 has transverse orientation, and has for example a substantially annular form. This rotor 12 also comprises a cylindrical core 34 which is interposed axially between the magnet wheels 31. In this case, this core 34 is formed by two half cores each belonging to one of the magnet wheels. Between the core 34 and the claws 33, the rotor 12 comprises a coil 35, which in this case comprises a winding hub and an electrical winding on this hub. For example, the collector rings 21 belonging to the collector 22 are connected by wired connections to the said coil 35. The rotor 12 can also comprise magnetic elements interposed between two adjacent claws 33.

As illustrated in the example in FIG. 2, the stator 15 comprises an annular cylindrical body 27 in the form of a set of metal plates provided with notches 37. Each notch 37 opens axially into front 38 and rear 39 axial end walls of the body 27, and is open radially in an inner wall 40 of the said body.

An electrical winding 28 is fitted on the body 27. This winding 28 passes through the notches 37 in the body 27 and forms a front chignon 29 and a rear chignon 30 on both sides of the body of the stator. The stator 15 can be equipped with notch insulation for fitting of an electrical winding 28 in the interior of the notches and/or with closure wedges 41 which permit the retention of the winding in the interior of the notches 37. The winding 28 is connected for example in the form of a star or also a triangle.

The winding 28 is formed by a plurality of phases, with each phase forming a winding 43. Each winding comprises at least one conductor passing through the notches 37, and forms the chignons together with all the phases. The winding 28 is connected electrically via phase outputs 42 to an electronic assembly 36.

The electronic assembly 36 comprises at least one electronic power module, which makes it possible to control a phase of the winding 28. This power module forms a voltage rectifier bridge, in order to transform the alternating voltage generated by the alternator 10 into a direct voltage, in particular in order to supply the battery and the on-board network of the vehicle with power.

When the electrical winding 28 is supplied electrically from the brushes, the rotor 4 is magnetised and becomes an inductor rotor with formation of North-South magnetic poles at the claws 19. This inductor rotor creates an induced alternating current in the armature stator when the shaft 3 is rotating. The rectifier bridge 9 then transforms this induced alternating current into a direct current, in particular in order to supply power to the loads and consumers of the on-board network of the motor vehicle, as well as to recharge its battery.

As illustrated in FIGS. 3 and 4, a winding 43 comprises undulating turns of one or a plurality of wires comprising a series of axial strands 44 which are received in a series of associated notches 37, and connection strands 45, 46 which connect the successive axial strands by extending alternately projecting relative to the front axial end wall and by projecting relative to the rear axial end wall. Thus, the upper connection strands 45 form the front chignon 29, and the lower connection strands 46 form the rear chignon 30 of the electrical winding 28.

As illustrated by FIG. 3, at least one of the windings 43 has a wire length which is shorter than that of the other windings. Wire length means the length of all of the wire between the portions of the wire which form the phase outputs 42. The lengths of the axial strands 44 of the different windings are identical, but the lengths of the connection strands 45, 46 are different.

In the example in FIG. 3, the electrical winding 28 is a double three-phase winding, i.e. comprising 6 phases or 6 windings 43. This winding 28 thus comprises a first phase system 47 and a second phase system 48, each comprising three windings 43. A series of notches 37 is associated with one of the six windings 43. Two consecutive notches of a single series of notches are separated by adjacent notches each corresponding to another series of notches associated with one of the five other windings 43. Thus, for a hexaphase stator as in the example taken here, five adjacent notches are left free between two notches of each series. In other words, the wires of a winding 43 are inserted in one notch out of six adjacent notches.

At least one winding 43 of the second phase system 48 has a wire length which is shorter than that of a winding 43 of the first phase system 47. In particular, the three windings 43 of the second phase system 48 each have a wire length which is shorter than that of the three windings 43 of the first phase system 47. Preferably, within a single phase system, the windings 43 have the same wire length.

Again in the example in FIG. 3, the first phase system 47 is the one which is inserted first in the body 27 of the stator. Thus, the windings of the second phase system 48 which have a shorter wire length are disposed radially closer to the inner wall 40 of the stator body 27 than the windings with a longer wire length, i.e. those of the first phase system 47.

In the example described here, the three phases of the first phase system 47 are inserted in a certain order, for example a first phase then a second phase then a third phase, then the three phases of the second phase system 48 are inserted in a certain order, in particular in the same order as those of the first system, i.e. firstly the first phase then the second phase then the third. Changing the order of insertion of the different phases would not constitute a departure from the context of the invention.

The direction of insertion of the windings 43 is indicated by an arrow in FIG. 3. The windings 43 are inserted one by one starting from the rear axial end wall 39 of the body 27, towards the front axial end wall 38 of the said body. The winding which is inserted first can be inserted to the maximum. As the windings are inserted, less and less space is available to insert the following windings, in particular because of the size of the front chignon 29. Thus, axial offsetting is created between the different maximum heights of the windings at the front chignon 29, and axial offsetting is created between the different maximum heights of the windings at the rear chignon 30. Maximum height means the maximum axial distance between the axial end wall 38, 39 of the corresponding body 27 and one of the corresponding connection strands 45, 46 of the winding 43.

In particular, as a result of the insertion method used here, the first winding inserted is the one which has a greatest maximum height at the front chignon 38, and the final winding inserted is the one which has the smallest maximum height at the said front chignon. Preferably, between these two windings, the other windings have respectively maximum heights which decrease progressively between that of the first winding inserted and that of the final winding inserted.

At the rear chignon 30, for the first phase system 47, the first winding inserted is the one which has the smallest maximum height, and the final winding inserted is the one which has the greatest maximum height, with the winding inserted between the first and the final winding having an intermediate maximum height. Similarly, for the second phase system 48, the first winding inserted is the one which has the smallest maximum height and the final winding inserted is the one which has a greatest maximum height, with the winding inserted between the first and the final windings having an intermediate maximum height.

The reduction of the wire lengths of the windings 43 of the second phase system 48 gives rise to discontinuity between the axial offsettings of the first phase system 47 and those of the second phase system 48. In FIG. 3, the broken lines illustrate the difference between windings without reduction of lengths according to the prior art, and windings with a reduction of length. Thus, the first winding inserted of the second phase system 48 has a maximum height which is smaller than that of the final winding inserted of the first phase system 47. For example, the second winding inserted of the second phase system 48 could also have a maximum height which is smaller than that of the final winding inserted of the first phase system 47. According to another example, the first winding inserted of the second phase system 48 has a maximum height which is smaller than that of the second winding inserted of the first phase system 47.

Finally, an axial height of the rear chignon 30 is obtained which is smaller than an axial height of the front chignon 29.

Preferably, the length of the winding 43 which has a shorter wire length is at the most equal to 98% of the length of the winding which has a longer wire length.

Again preferably, the length of the winding which has a shorter wire length is at least equal to 95% of the length of the winding which has a longer wire length.

Thus, the reduction of length is between 2% and 5% of the total wire length. For example a wire of a winding of the first phase system 47 has a length of 1060 mm, and a wire of a winding of the second phase system 48 has a length of 1030 mm. The total reduction of the height of the chignons can be as much as 8 mm, i.e. a maximum reduction of 4 mm for a chignon.

This difference in length gives rise to a difference in resistance between the winding which has a shorter wire length and the winding which has a longer wire length, which difference is approximately 3%, with the winding with a shorter wire length having the lowest resistance. An imbalance of resistance of this type between the two phase systems does not have any effect on the performance of the rotary electrical machine.

Preferably, the wire diameter used for the different windings remains the same from one phase system to another.

FIGS. 4 to 7 explain an example of formation of a winding 43. In this example, a winding 43 comprises a first half-phase 49 forming an outer layer 51 of turns, and a second half-phase 50 forming an inner layer 52 of turns superimposed radially in the notch 37 on the outer layer 51, with the inner layer 52 being closer radially to the inner wall 40 of the body 27 than the outer layer 51. The axial strands 44 of each half-phase are disposed in the notches 37, such that the axial strands of the second half-phase 50 are radially closer to the inner wall 40 than the axial strands of the first half-phase 49. The connection strands 45, 46 of the first half-phase 49 form outer chignons belonging to the outer layer 51, and the connection strands 45, 46 of the second half-phase 50 form inner chignons belonging to the outer layer 52. Each front 29 and rear 30 chignon is composed of an inner chignon and an outer chignon.

Each half-phase 49, 50 comprises a superimposition of identical turns in the form of regular stars with an axis A, the axis A being coaxial to the axis X of the machine. For example, in FIG. 5, each half-phase 49, 50 comprises three turns. The turns of a single half-phase are superimposed.

The turns of each half-phase 49, 50 of a single winding 43 undulate in opposition. Thus, the upper connection strands 45 of the first half-phase 49 and the upper connection strands 45 of the second half-phase 50 are offset angularly around the axis X, and similarly for the lower connection strands 46. In addition, the turns of the first half-phase 49 are wound for example in the clockwise direction, and the turns of the second half-phase 50 are wound in the anticlockwise direction.

The two half phases are connected to one another by a connection portion 53.

According to one embodiment, the wire length of each turn of the first half-phase 49 and that of each turn of the second half-phase 50 are identical for a single winding 43.

According to a variant embodiment, the wire length of each turn of the second half-phase 50 is longer than the wire length of each turn of the second half-phase 49, such that a projecting axial height of the inner chignons is greater than a projecting axial height of the outer chignons. For example, the wire length of each turn of the second half-phase 50 is longer by 2% to 10% than the wire length of each turn of the first half-phase 49.

This type of winding is known by the name of “distributed undulating”. A winding of this type and its insertion method are described for example in document FR 2846481.

In a first assembly step, this phase winding 43 is formed flat, i.e. the turns each extend on a plane substantially perpendicular to the axis A. In a second assembly step, the winding 43 is fitted on the body 27 of the stator by means of deformation. More specifically, the winding 43 is positioned in the notches 37 by progressive torsion of the axial strands 44 axially from the rear forwards and by simultaneous tilting of all the axial strands from a direction perpendicular to the axis A, to a direction parallel to the said axis A. This deformation is obtained for example by sliding an insertion block not represented here.

These assembly steps are then repeated such as to insert the other windings 43 in order to form the electrical winding 28.

The invention has been described with reference to a method in which the windings are fitted in succession one after another in the stator body. However, the invention is also applicable for assembly methods in which at least two windings, or even all the windings, are fitted simultaneously in the stator body.

The present invention has applications in particular in the field of stators for alternators or reversible machines, but it could also be applied to any type of rotary machine.

It will be appreciated that the foregoing description has been provided purely by way of example, and does not limit the field of the present invention, a departure from which would not be constituted by replacing the different elements by any other equivalents. For example, the invention is applicable to an electrical winding comprising more than six phases, such as, for example, seven phases. Thus, a departure from the context of the invention would not be constituted by increasing or decreasing the number of phases of the stator.

1. A stator for a rotary electrical machine for a motor vehicle, the stator comprising:
a body comprising notches which open axially into front and rear axial end walls of the body, and are open radially in an inner wall of the body;
at least two windings each forming a phase of the stator, each winding comprising undulating turns of wire which comprise a series of axial strands received in an associated series of notches, and connection strands which connect the successive axial strands, by extending alternately projecting relative to the front axial end wall and projecting relative to the rear axial end wall,
wherein one winding has a wire length which is shorter than that of the other winding.

2. The stator according to claim 1, wherein the stator comprises two phase systems, each phase system comprising at least one winding, and in that at least one winding of the second phase system has a wire length which is shorter than that of a winding of the first phase system.

3. The stator according to claim 2, wherein each phase system comprises a plurality of windings, and all the windings of the second phase system each have a wire length which is shorter than that of the windings of the first phase system.

4. The stator according to claim 3, wherein within a single phase system, the windings have the same wire length.

5. The stator according to claim 1, wherein the winding with a shorter wire length is disposed radially closer to the inner wall of the stator body than the winding with the longer wire length.

6. The stator according to claim 1, wherein the length of the winding which has a shorter wire length is at the most equal to 98% of the length of the winding which has a longer wire length.

7. The stator according to claim 1, wherein the length of the winding which has a shorter wire length is at least equal to 95% of the length of the winding which has a longer wire length.

8. The stator according to claim 1, wherein a winding comprises a first half-phase forming an outer layer of turns and a second half-phase forming an inner layer of turns superimposed radially in the notch on the outer layer, and the axial strands of each half-phase are disposed in the notches such that the axial strands of the second half-phase are radially closer to the inner wall than the axial strands of the first half-phase, with the connection strands of the first half-phase forming outer chignons and the connection strands of the second half-phase forming inner chignons.

9. The stator according to claim 8, wherein the turns of each half-phase of a single winding undulate in opposition.

10. The stator according to claim 8, wherein the wire length of each turn of the first half-phase and that of each turn of the second half-phase are identical for a single winding.

11. The stator according to claim 8, wherein the wire length of each turn of the second half-phase is longer than the wire length of each turn of the first half-phase, such that a projecting axial height of the inner chignons is greater than a projecting axial height of the outer chignons.

12. A rotary electrical machine comprising a stator according to claim 1.

13. The rotary electrical machine according to claim 12, forming an alternator or an alternator-starter or a reversible machine.
